(19) United States
(12) Patent Application Publication
(10) Pub. No.: US 2008/0037394 A1
(43) Pub. Date: Feb. 14, 2008

(54) Bit Synchronization Detection Means

(75) Inventors: Aalbert Stek, Eindhoven (NL); Cornelis Marinus Schep, Eindhoven (NL); Constant Paul Marie Jozef Baggen, Eindhoven (NL); Josephus Arnoldus Henricus Maria Kahlman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/557,350

(22) PCT Filed: May 27, 2003
(86) PCT No.: PCT/IB03/02334

§ 371 Date: Nov. 21, 2005

(51) Int. Cl. G11B 5/09

(52) U.S. Cl. 369/47.36

(57) ABSTRACT

Detection means for detecting information in a signal, comprising integration means for integrating the signal over time such that the integration means is periodically reset at about the start time reference of a periodic time interval; and a sample&hold circuit for periodically sampling and holding the integrated signal (int) at about an end time reference of the periodic time interval and thereby delivering a further signal (fs). The detection means further comprises a chain (CHDL) of signal time delay elements, an input of the chain (CHDL) being coupled to receive the further signal (fs); and combining means (CBMNS) having combining inputs coupled to signal taps of the chain (CHDL), such that the number of the combining inputs and the position of coupling the combining inputs to the signal taps of the chain (CHDL) correspond to the information in the signal.

The invention relates to detection means for detecting information in a signal, comprising integration means for integrating the signal over time, such that the integration means is periodically reset at about the start time reference of a periodic time interval; and a sample&hold circuit for periodically sampling and holding the integrated signal at about an end time reference of the periodic time interval and thereby delivering a further signal.

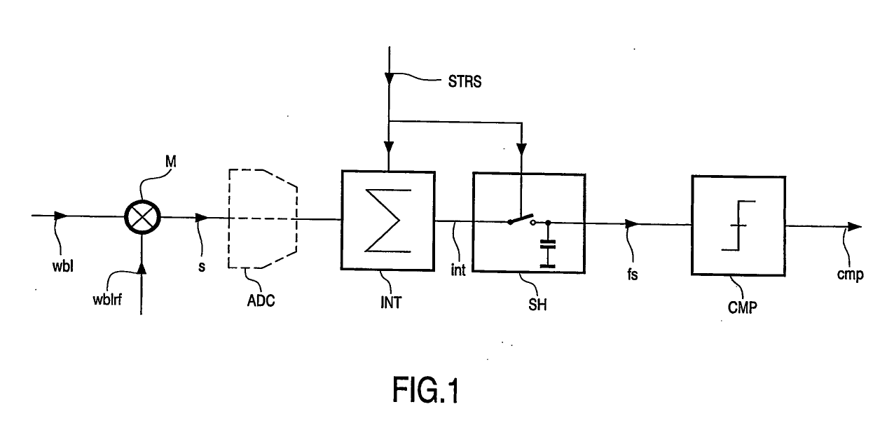

Such detection means is known from the general state of the art as shown in FIG. 1. The known detection means can be used for various purposes. In the example of FIG. 1 it is used for the detection of address data in a so-called wobble signal wbl originating from a disk, such as an optical disk. The known detection means of FIG. 1 comprises a multiplier M for multiplying the wobble signal wbl by a wobble reference signal wblrf, and thereby supplying a signal s as a result of the multiplication; integration means INT coupled for receiving the signal s and for supplying an integrated signal int as a result of the integration; a sample&hold circuit SH coupled for receiving the integrated signal int and for supplying a further signal fs as a result; and a comparator CMP coupled for receiving the further signal fs and for supplying a comparator output signal cmp. The signal s may be directly coupled to the integration means INT, so that the integration is performed in the analog domain. Alternatively, the signal s is first digitized by an analog-to-digital converter ADC and then coupled to the integration means INT, so that the integration is performed in the digital domain.

It is to be noted that in the literature the combination of the integration means INT and the sample&hold circuit SH is often denoted an “integrate and dump filter”.

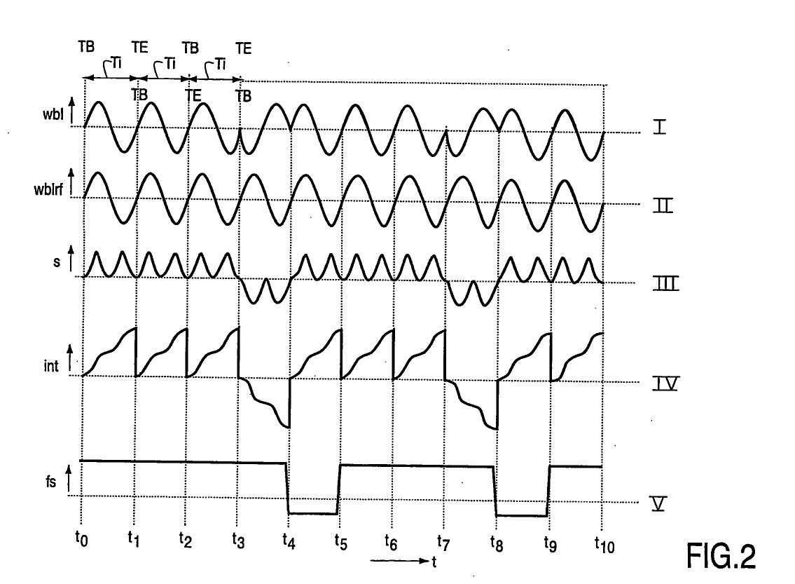

The known detection means as shown in FIG. 1 is now further explained in conjunction with the signal diagrams I, II, III, IV, and V as shown in FIG. 2. In the example, the detection of a synchronization bit, which will be further denoted bitsync, in the wobble signal wbl is demonstrated. Diagram I shows the wobble signal wbl. It starts with 3 consecutive sinewave periods between time instants t₀ and t₃. It is then followed by an inverted sinewave period between time instants t₃ and t₄. This inverted sinewave period is a bitsync. From time instant t₄ up tot t₇ the wobble signal wbl is continued normally, that is to say as if the bitsync did not take place. Also between time instants t₇ and t₈ a bitsync is present in the wobble signal wbl. Diagram II shows the wobble reference signal wblrf which is in fact equal to the wobble signal wbl, such that each bitsync is replaced by a non-inverted sinewave period, so that a monotonic wobble signal is obtained. The generation of the wobble reference signal wblrf may be performed by all known methods, for instance with the aid of a PLL (Phase Locked Loop). Diagram III shows the signal s which is a mathematical multiplication of the wobble signal wbl and the wobble reference signal wblrf. The signal s only becomes negative during the bitsyncs in the wobble signal wbl. Therefore, detection of the bitsyncs is possible in principle by directly coupling the signal s to a comparator. In practice, however, the signal s does not have the ideal form as indicated in diagram III. In some cases the signal s is a (very) noisy signal. As a consequence the comparator may give a false bitsync detection. For this reason the signal s is first periodically integrated. The integrated signal int is shown in diagram IV. The length of one time interval Tᵢ corresponds to one sinewave period. The start and end times of the time intervals Tᵢ are denoted T_{B} and T_{E}, respectively. About each start time T_{B} the integration means INT is reset by a start/reset signal STRS (see FIG. 1), and the sample&hold circuit SH enters in the holding phase. Just (very close) before each ending time T_{E} the sample&hold SH circuit enters in the sampling phase. The resultant further signal fs is supplied by the sample&hold circuit, and is indicated in diagram V. Now if this integrated signal fs is coupled to a comparator CMP, a more reliable bitsync detection is possible.

Sometimes the integrated signal int is still burdened with quite a lot of noise, so that the comparator cmp can still make a wrong decision, causing false bitsync detection or missed bitsyncs.

Therefore, it is an object of the invention to provide bitsync detection means with an increased reliability for detecting a correct position for a bitsync.

To this end, according to the invention, the detection means of the type defined in the opening paragraph is characterized in that the detection means comprises a chain of signal time delay elements, an input of said chain being coupled to receive the further signal; and combining means having combining inputs coupled to signal taps of the chain, the number of the combining inputs and the positions of coupling of the combining inputs to the signal taps of the chain corresponding to the information in the signal.

In fact, the comparator which is used in the known detection means is now replaced by the chain of signal time delay elements and the combining means. By so doing it is possible to determine a bitsync by taking into account a large number of wobble periods, so that (statistical) calculations can be carried out. The appropriate coupling of the combining inputs to the signal taps is determined by the characteristics of the information in the signal. Thus a “pattern matching principle” for detecting bitsyncs, or other special characteristics of the information, can be carried out. In the known detection means, a decision whether there is a bitsync in the wobble signal or not is taken after each wobble period (sine wave period). This is in contrast to the new detection means, which takes into account a large number of wobble periods. As a consequence of this a more reliable bitsync detection is possible (due to an increased S/N-ratio).

An embodiment of the invention may be characterized in that the information comprises a bit synchronization part followed by a word synchronization part or followed by one of a plurality of possible types of data bit parts, and in that the combining means delivers a combining output signal corresponding to the bit synchronization part followed by a word synchronization part and delivers combining output signals for each bit synchronization part followed by a possible type of data bit part.

Usually there are two types of data bit parts, a data bit part representing a logic “0”, and a data bit part representing a logic “1”. These types of data bit parts will be further denoted data ZERO and data ONE, respectively.

A further embodiment of the invention may be characterized in that the detection means comprises processing means for processing all the combining output signals, the processing is accomplished such that during a predetermined number of the time intervals, in each time interval the lowest (highest) signal value of the signal values of all the combining output signals is detected together with an accompanying position number corresponding to the corresponding time interval, and that the position number corresponding to the lowest (highest) detected signal value within the predetermined number of time intervals is deemed to be the correct position of the bit synchronization part followed by a word synchronization part. By so doing, the so-called “pattern matching principle” is carried out.

An even further embodiment of the invention may be characterized in that the detection means comprises further processing means for further processing the deemed correct positions delivered by the processing means of the bit synchronization part followed by a word synchronization part, the further processing means examining the positions of the deemed correct positions of the bit synchronization part followed by a word synchronization part during a substantially longer period of time as compared with the predetermined number of time intervals, the further processing means comprising an up/down counter having a registered value which is incremented (decremented) by a unit value up to a predetermined reference value of the up/down counter whenever a deemed correct position of the bit synchronization part followed by a word synchronization part occurs at the position expected by the further processing means, and which registered value is decremented (incremented) by a unit value whenever a deemed correct position of the bit synchronization part followed by a word synchronization part does not occur at the position expected by the further processing means, the further processing means delivering positions of the bit synchronization part followed by a word synchronization part with improved position reliability accomplished by the manner of operation of the further processing means in which the position of the bit synchronization part followed by a word synchronization part which is delivered by the further processing means is equal to the position expected by the further processing means as long as the registered value is above (below) a further predetermined reference value, and in which the position of the bit synchronization part followed by a word synchronization part which is delivered by the further processing means is equal to the position delivered by the processing means when the registered value becomes equal to the further predetermined reference value, in which latter case the up/down counter is reset.

Despite the improved reliability of the bitsync detection, it still may happen that bitsyncs are missed or wrongly detected. The reliability is further increased by the application of the further processing means. Basically it operates as a kind of electronic “flywheel”. Thus missed bitsyncs, or bitsyncs which do not have the location expected by the “flywheel”, are simply added by the “flywheel”. If wrong bitsync detection occurs too frequently, this can be caused by a change in the signal. The “flywheel” is then reset accordingly.

The invention further relates to an apparatus in general as defined in claim 5, and specifically to an optical disk drive and a magneto-optical disk drive as defined in claims 6 and 7, respectively.

The invention further relates to a method of detecting address data in a signal, comprising the steps of:
periodically integrating the signal over time during a time interval,
sampling and holding the integrated signal at about the end of each time interval and thereby delivering a further signal,
delaying the further signal and thereby providing a plurality of delayed signals having various delays,
combining at least part of the delayed signals in a manner which corresponds to the address data in the signal.

Advantageous embodiments of the method are defined in claims 9 and 10.

The principle of the detection means can also be applied without the integration means. This is specified in claim 11.

The invention will be described in more detail with reference to the accompanying drawings, in which:

FIG. 1 is a circuit diagram of known detection means;

FIG. 2 is a set of signal diagrams I-V, for explaining the known detection means;

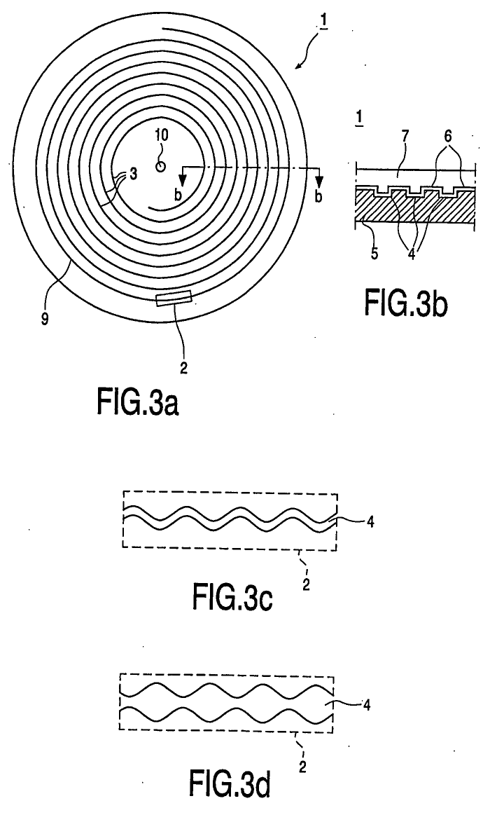

FIG. 3 (a-d) shows a record carrier (disk);

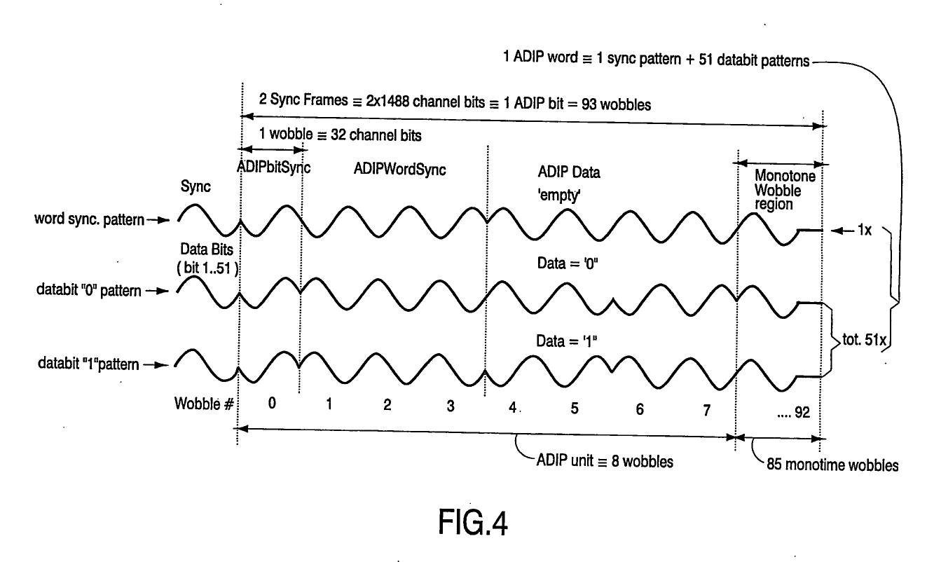

FIG. 4 shows bi-phase wobble modulation;

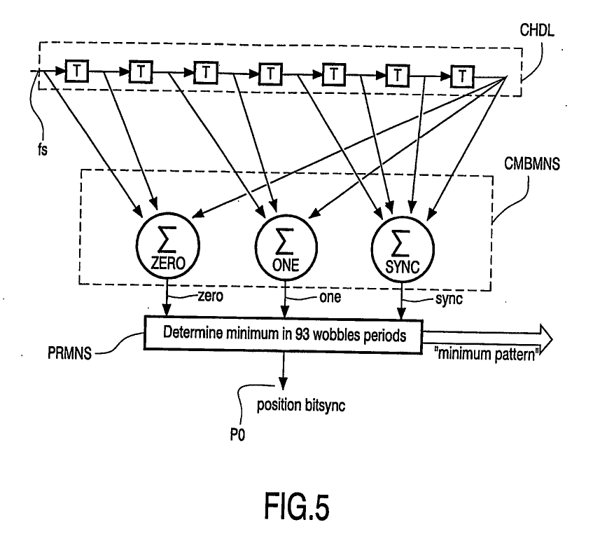

FIG. 5 is a circuit diagram of an embodiment of detection means according to the invention;

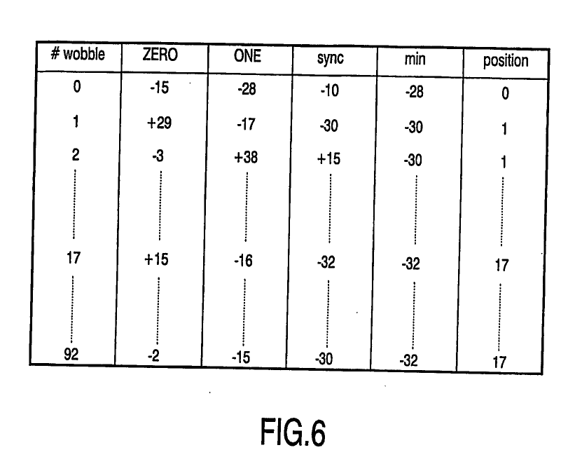

FIG. 6 is a table for further explaining the invention;

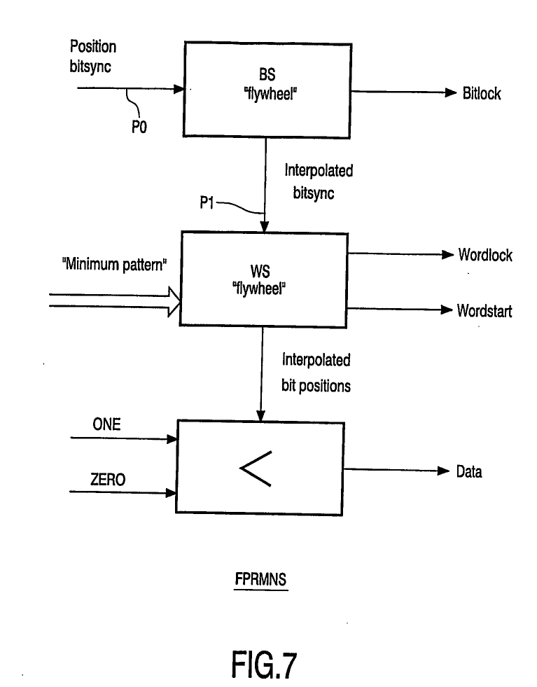

FIG. 7 is a circuit diagram of a further embodiment of the detection means according to the invention; and

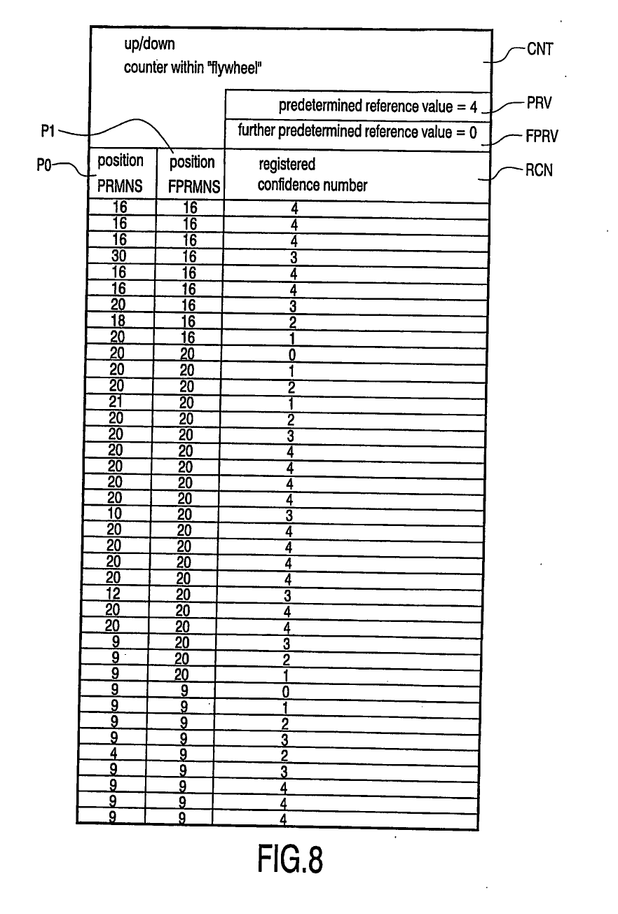

FIG. 8 is a table for further explaining the further embodiment of the invention.

In these Figures parts or elements having like functions or purposes bear the same reference symbols.

FIG. 3a shows a disk-shaped record carrier 1 which comprises a continuous track 9 intended for recording, which track is arranged in a spiraling pattern of turns 3. The turns may also be arranged concentrically instead of spiraling. The track 9 on the record carrier is indicated by a servo track in which, for example, a pregroove 4 enables a read/write head to follow the track 9 during scanning. A servo track may also be formed, for example, by regularly distributed sub-tracks which, in the servo track system, periodically cause signals to occur. FIG. 3b shows a cross-section taken on a line b-b of the record carrier 1, in which a transparent substrate 5 is covered by a recording layer 6 and a protective layer 7. The pregroove 4 may also be arranged as a land or be a material property that differs from its environment. The recording layer 6 may be deposited in an optical, magneto-optical, or magnetic manner by an apparatus for reading and/or writing information such as the known CD recordable or hard disk for computer use. FIGS. 3c and 3d show two examples of a periodic modulation (wobble) of the pregroove. This wobble causes an additional signal to arise in a servo track recorder. A comprehensive description of the CD system comprising disk information can be found in U.S. Pat. No. 4,901,300 and U.S. Pat. No. 5,187,699.

FIG. 4 shows bi-phase wobble modulation. An upper trace shows the wobble modulation for a word sync pattern, a second and third trace show the wobble modulations for data bits (one out of Data Bits 1 to 51). Predetermined phase patterns are used for indicating a synchronizing symbol (ADIP (ADdress In Pregroove) bit sync) and a synchronization of the full address word (ADIP word sync), and for the respective data bits (ADIP Data=‘0’, and ADIP data=‘1’). The ADIP bit sync is indicated by a single inverted wobble (wobble # 0). The ADIP word sync is indicated by three inverted wobbles immediately following the ADIP bit sync, whereas data bits have non-inverted wobbles in this area (wobble # 1 to 3). An ADIP Data area comprises a number of wobble periods assigned to represent one data bit, in FIG. 4 the wobble periods are numbered 4 to 7 (=wobble # 4 to 7). The wobble phase in the first half of the ADIP Data area is inverse to the wobble phase in the second half of the area. As such each bit is represented by two sub-areas having different phases of the wobble, i.e. called bi-phase. Data bits are modulated as follows: ADIP Data=‘0’ is represented by 2 non-inverted wobbles followed by two inverted wobbles, and ADIP data=‘1’ by the opposite. In this example the modulation for data bits is fully symmetrical, giving equal error probabilities for both data bit values. However, other combinations of wobbles and inverted wobbles, or other phase values may be used. Monotonic wobbles may be used after the first data bit, or further data bits may be encoded thereafter. Usually a large majority of the wobbles is not modulated (i.e. has the nominal phase) for ensuring an easy lock and a stable output of a PLL. In this example the 8 possibly modulated wobbles are followed by 85 non-modulated (i.e. monotonic) wobbles (wobble # 8 to 92). The output frequency of the PLL has to be as stable as possible, because during writing the write clock is derived from the PLL output.

An ADIP word comprises 52 bits, which corresponds to 52*93 wobbles, and 1 wobble=32 channel bits. For the DVD format a channel code EFM+ is used, and channel bits are clustered in EFM sync frames of 1488 channel bits. Hence one ADIP bit corresponds to 2 EFM sync frames, and the ADIP word corresponds to 4 sectors in the DVD format. An ECC (Error Correction Code) block in the DVD format comprises 16 sectors, hence an ECC block corresponds to 4 ADIP words. So one ADIP Word Sync is used every fourth sector to indicate the start of a new address (i.e. a new full ADIP word).

Briefly stated, the detection of the ADIP words is done in a number of steps:
STEP 1: Lock on to the wobble (with the aid of a PLL).
STEP 2: Detect the position of the bitsync or, in other words, detect the position of the ADIP unit.
STEP 3: Lock on to the bitsync and use a “flywheel” to stay in lock even if a bitsync is missed.
STEP 4: Detect the SYNC.
STEP 5: Lock on to the SYNC and use a “flywheel” to stay in lock even if a wordsync is missed.
STEP 6: Detect data bits ZERO or ONE.
STEP 7: Use ECC to correct errors and extract the correct addresses.

### The invention is mainly focused on STEPS 2, 3, 4, 5, and 6.

FIG. 5 shows a circuit diagram of an embodiment of detection means according to the invention. The circuit as shown in FIG. 1 also belongs to this embodiment, except for the comparator CMP. The detection means further comprises a chain CHDL of signal time delay elements, an input of the chain CHDL being coupled to receive the further signal fs; and combining means CBMNS having combining inputs coupled to signal taps of the chain CHDL, such that the number of the combining inputs and the positions of coupling the combining inputs to the signal taps of the chain CHDL correspond to the information in the signal s. In this example the information comprises a bit synchronization part followed by a word synchronization part which will be further denoted SYNC, and possible data ZERO and data ONE types of data bit parts. The combining means CBMNS delivers a combining output signal “zero” corresponding to data ZERO, a combining output signal “one” corresponding to data ONE, and a combining output signal “sync” corresponding to SYNC.

The detection means further comprises processing means PRMNS for processing the combining output signals “zero”, “one” and “sync”. The processing is accomplished such that during a predetermined number of time intervals Tᵢ (see FIG. 2), in each time interval Tᵢ the lowest (highest) signal value of the signal values of the combining output signals “zero”, “one” and “sync” is detected together with an accompanying position number corresponding to the corresponding time interval Tᵢ. The position number corresponding to the lowest (highest) detected signal value within the predetermined number of time intervals Tᵢ is deemed to be the correct position P₀ of the SYNC. As is shown in the Table of FIG. 6, for every wobble (wobble 0 to wobble 92) the minimum value of a ZERO, ONE, or SYNC is determined and retained with the corresponding position number. In this example the minimum detected value is −32. This means that SYNC detection occurs where the deemed correct position P₀ is 17. The pattern belonging to this 17^{th} wobble is indicated as the “Minimum pattern” in FIG. 5. In this patent application, by way of example, the detection means is defined such that a determination of a minimum value (see FIG. 6) and the associated “Minimum pattern” which corresponds to the “best pattern matching principle” is carried out. It is also possible, however, to define the detection means such that a maximum value and the associated “Maximum pattern” are determined. The “Maximum pattern” then corresponds to the “best pattern matching principle”.

FIG. 7 shows a circuit diagram of a further embodiment of the detection means according to the invention in which the detection means further comprises further processing means FPRMNS for further processing the deemed correct positions P₀ delivered by the processing means PRMNS. This further embodiment deals with STEPS 3-6. The further processing means FPRMNS examines the positions of the deemed correct positions P₀ of the SYNC during a substantially longer period of time as compared with the predetermined number of time intervals Tᵢ. The further processing means FPRMNS is now further explained in conjunction with the Table of FIG. 8 in which the “flywheel principle” is illustrated.

The further processing means FPRMNS comprises an up/down counter CNT having a registered value RCN which is incremented (decremented) by a unit value up to a predetermined reference value PRV of the up/down counter CNT, whenever a deemed correct position P₀ of the SYNC occurs at the position expected by the further processing means FPRMNS. In this example the predetermined reference value PRV is equal to 4. The registered value RCN is decremented (incremented) by a unit value whenever a deemed correct position P₀ of the SYNC does not occur at the position expected by the further processing means FPRMNS. The higher the registered value RCN, the higher the “confidence” that the positions P₁ delivered by the further processing means FPRMNS are correct. The further processing means FPRMNS which delivers positions P₁ of the SYNC with improved position reliability is accomplished by the manner of operation of the further processing means FPRMNS in which the position P₁ of the SYNC is equal to the position expected by the further processing means FPRMNS as long as the registered value RCN is above (below) a further predetermined reference value FPRV, while the position P₁ of the SYNC is equal to the position P₀ delivered by the processing means PRMNS when the registered value RCN becomes equal to the further predetermined reference value FPRV, in which latter case the up/down counter CNT is reset. In this example the further predetermined reference value FPRV is equal to zero. In FIG. 7 there are in fact two “flywheels” indicated: a BS (Bitsync) and a WS (wordsync) “flywheel”. Both have similar operation. Therefore, the operation of only one “flywheel” is shown in FIG. 8.

Consider the table of FIG. 8. The first (upper) row contains positions PRMNS=16, FPRMNS=16, and RCN=4. RCN=4 means there is a high “confidence” that P₁ is a correct position. As long as RCN is above zero, the position delivered by the further processing means FPRMNS is kept constant, even if the position P₀ is changed, which occurs for the first time in the 4^{th} row (P₀=30), the only effect being a lowering of the registered value RCN by one unit (in this case from 4 to 3). In the 10^{th} row RCN becomes 0. The effect is that the up/down counter CNT is reset and P₁ assumes a new value delivered by P₀. Then the procedure is repeated.

It is to be emphasized that the detection means are not limited to the examples disclosed in this patent application. The detection method may also be applied, for example, to Blu ray disks (formerly denoted DVR) in which MSK (Minimum Shift Keying) is applied. MSK is well known from the literature. Briefly summarized, in MSK a bitsync is spread over 3 wobbles: one wobble period having a cosinewave with 1.5 times the monotonic wobble frequency, a wobble period one time the monotonic wobble frequency, and a wobble period with 1.5 times the monotonic wobble frequency.

Alternative modulation forms may also be used.

1. Detection means for detecting information in a signal (s), comprising integration means (INT) for integrating the signal (s) over time, such that the integration means (INT) is periodically reset at about the start time reference (T_{B}) of a periodic time interval (Tᵢ); and a sample&hold circuit (SH) for periodically sampling and holding the integrated signal (int) at about an end time reference (T_{E}) of the periodic time interval (Tᵢ) and thereby delivering a further signal (fs), characterized in that the detection means comprises a chain (CHDL) of signal time delay elements, an input of the chain (CHDL) being coupled to receive the further signal (fs); and combining means (CBMNS) having combining inputs coupled to signal taps of the chain (CHDL), the number of the combining inputs and the positions of coupling of the combining inputs to the signal taps of the chain (CHDL) corresponding to the information in the signal (s).

2. Detection means as claimed in claim 1, characterized in that the information comprises a bit synchronization part followed by a word synchronization part or followed by one of a plurality of possible types of data bit parts, and in that the combining means (CBMNS) delivers a combining output signal corresponding to the bit synchronization part followed by a word synchronization part and delivers combining output signals for each bit synchronization part followed by a possible type of data bit part.

3. Detection means as claimed in claim 2, characterized in that the detection means comprises processing means (PRMNS) for processing all the combining output signals, the processing is accomplished such that, during a predetermined number of the time intervals (Tᵢ), in each time interval (Tᵢ) the lowest (highest) signal value of the signal values of all the combining output signals is detected together with an accompanying position number corresponding to the corresponding time interval (Tᵢ), and that the position number corresponding to the lowest (highest) detected signal value within the predetermined number of time intervals (Tᵢ) is deemed to be the correct position (P₀) of the bit synchronization part followed by a word synchronization part.

4. Detection means as claimed in claim 3, characterized in that the detection means comprises further processing means (FPRMNS) for further processing the deemed correct positions (P₀) delivered by the processing means (PRMNS) of the bit synchronization part followed by a word synchronization part, the further processing means (FPRMNS) examining the positions of the deemed correct positions (P₀) of the bit synchronization part followed by a word synchronization part during a substantially longer period of time as compared with the predetermined number of time intervals (Tᵢ), the further processing means (FPRMNS) comprising an up/down counter (CNT) having a registered value (RCN) which is incremented (decremented) by a unit value up to a predetermined reference value (PRV) of the up/down counter (CNT), whenever a deemed correct position (P₀) of the bit synchronization part followed by a word synchronization part occurs at the position expected by the further processing means (FPRMNS), and which registered value (RCN) is decremented (incremented) by a unit value whenever a deemed correct position (P₀) of the bit synchronization part followed by a word synchronization part does not occur at the position expected by the further processing means (FPRMNS), the further processing means (FPRMNS) delivering positions (P₁) of the bit synchronization part followed by a word synchronization part with improved position reliability accomplished by the manner of operation of the further processing means (FPRMNS) in which the position (P₁) of the bit synchronization part followed by a word synchronization part which is delivered by the further processing means (FPRMNS) is equal to the position expected by the further processing means (FPRMNS) as long as the registered value (RCN) is above (below) a further predetermined reference value (FPRV), and in which the position (P₁) of the bit synchronization part followed by a word synchronization part which is delivered by the further processing means (FPRMNS) is equal to the position (P₀) delivered by the processing means (PRMNS) when the registered value (RCN) becomes equal to the further predetermined reference value (FPRV), in which latter case the up/down counter (CNT) is reset.

5. An apparatus for at least reading data from a disk (1) with address data (2) available on said disk (1), comprising means for deriving a signal (s) during reading of the disk (1), which signal (s) is a representation of the address data (2), and comprising detection means as defined in one of the preceding claims.

6. An optical disk drive for at least reading data from an optical disk (1) with address data (2) available in a pre-groove (4) of said optical disk (1), comprising means for deriving a signal (s) during reading of the optical disk (1), which signal (s) is a representation of the address data (2), and comprising detection means as defined in claim 1, 2, 3, or 4.

7. A magneto-optical disk drive for at least reading data from a magneto-optical disk (1) with address data (2) available in a pre-groove (4) of said magneto-optical disk (1), comprising means for deriving a signal (s) during reading of the magneto-optical disk (1), which signal (s) is a representation of the address data (2), and comprising detection means as defined in claim 1, 2, 3, or 4.

8. A method of detecting address data (2) in a signal (s), comprising the steps of:
periodically integrating the signal (s) over time during a time interval (Tᵢ),
sampling and holding the integrated signal (int) at about the end (T_{B}) of each time interval (Tᵢ) and thereby delivering a further signal (fs),
delaying the further signal (fs) and thereby providing a plurality of delayed signals having various delays,
combining at least part of the delayed signals in a manner which corresponds to the address data (2) in the signal (s).

9. A method of detecting address data (2) in a signal (s), which address data (2) comprises a bit synchronization part followed by a word synchronization part or followed by one of a plurality of possible types of data bit parts, the method comprising the steps of:
periodically integrating the signal (s) over time during a time interval (Tᵢ),
sampling and holding the integrated signal (int) at about the end (T_{B}) of each time interval (Tᵢ) and thereby delivering a further signal (fs),
delaying the further signal and thereby providing a plurality of delayed signals having various delays,
combining at least part of the delayed signals in a manner which corresponds to the address data (2) in the signal (s), and thereby delivering a combining output signal corresponding to the bit synchronization part followed by a word synchronization part, and thereby delivering combining output signals for each bit synchronization part followed by a possible type of data bit part.

10. A method as claimed in claim 9, characterized in that the method further comprises the step of processing all the combining output signals such that, during a predetermined number of the time intervals (Tᵢ), in each time interval (Tᵢ) the lowest (highest) signal value of the signal values of all the combining output signals is detected together with an accompanying position number corresponding to the associated time interval (Tᵢ), and that the position number corresponding to the lowest (highest) detected signal value within the predetermined number of time intervals (Tᵢ) is deemed to be the correct position (P₀) of the bit synchronization part followed by a word synchronization part.

11. Detection means for detecting information in a signal (fs), comprising a chain (CHDL) of signal time delay elements, an input of the chain (CHDL) being coupled to receive the signal (fs); and combining means (CBMNS) having combining inputs coupled to signal taps of the chain (CHDL), the number of the combining inputs and the positions of coupling of the combining inputs to the signal taps of the chain (CHDL) corresponding to the information in the signal (fs).
